(19) United States
(12) Patent Application Publication
(10) Pub. No.: US 2025/0021732 A1
(43) Pub. Date: Jan. 16, 2025

(54) SELECTING METHOD OF NON-SIMPLIFIED REGION OF 3D MODEL AND SIMPLIFICATION MECHANISM OF 3D MODEL

(71) Applicant: UNIVERSAL SCIENTIFIC INDUSTRIAL ( SHANGHAI ) CO., LTD., SHANGHAI (CN)

(72) Inventors: Ji-Min LIN, SHANGHAI (CN); Wei-Yuan LIN, Shanghai (CN)

(21) Appl. No.: 18/472,730

(22) Filed: Sep. 22, 2023

(30) Foreign Application Priority Data
Jul. 10, 2023 (CN) 202310841452.1

(51) Int. Cl. G06F 30/31; G06F 30/392

(52) U.S. Cl. CPC G06F 30/31; G06F 30/392

(57) ABSTRACT

A selecting method of a non-simplified region of a 3D model of a multilayer metal circuit structure is used for selecting a first non-simplified region in a complete 3D model of a layout design of a multilayer metal circuit structure. The complete 3D model contains multiple layout layers. The electing method of the first non-simplified region includes at least one of first to fourth selecting modes. Through the selecting method of the non-simplified region of the present invention, the entire complete 3D can be effectively simplified in a programmed manner, shortening the overall electrical simulation time.

### BACKGROUND OF THE INVENTION

### 1. Field of the Invention

The present invention relates to the modeling and electrical simulation of a 3D model in the layout design of a multilayer metal circuit structure, in particular to a method for selecting non-simplified regions of a 3D model in the layout design of a multilayer metal circuit structure and an automatic simplification mechanism, which can effectively simplify the 3D model of a multilayer metal circuit structure and accelerate the obtaining of electrical simulation results.

### 2. Description of the Related Art

When designing the layout of a multilayer metal circuit structure (such as a circuit board), engineers need to conduct electrical simulations on the 3D model of the multilayer metal circuit structure to ensure the integrity of the high-speed signals transmitted in the multilayer metal circuit structure. As the design of the layout of the multilayer metal circuit structure becomes more and more complex, the layout layers of the existing multilayer metal circuit structure may be as high as twelve layers or more. Moreover, as the speed of transmission signals transmitted in the multilayer metal circuit structure to be simulated is getting faster and faster (for example, transmission speeds exceeding 5 GHz, radio frequency signals, or transmission signals supporting interfaces such as PCIe4, USB 3.2, and Thunderbolt), and more and more projects require electrical simulation, if engineers simply use the complete 3D model of the multilayer metal circuit structure to conduct electrical simulations on the multilayer metal circuit structure, without simplifying the above complete 3D model, the solution of the electrical simulation of the complete 3D model will be very time-consuming, and even affect the subsequent delivery schedule of chip placement.

In order to effectively solve the time-consuming problem of solving the electrical simulation of the above-mentioned complete 3D model, under normal circumstances, experienced engineers will simplify the regions that do not affect the accuracy of the solution in the complete 3D model of the multilayer metal circuit structure based on their own experience to speed up the solution of the electrical simulation. However, the above method of simplifying the model still relies on manual judgment to simplify the layout of the multilayer metal circuit structure, that is, it is impossible to automatically and more quickly conduct electrical simulations on the multilayer metal circuit structure. As such, the existing method of electrical simulation of multilayer metal circuit structure is not good enough and still has room for improvement.

### SUMMARY OF THE INVENTION

In view of this, one of the objectives of the present invention is to improve various deficiencies in the existing methods of electrical simulation of multilayer metal circuit structures, and to propose a new selecting method of non-simplified regions of 3D model of multilayer metal circuit structures and an automatic simplification mechanism of the 3D model, which can efficiently and automatically establish a simplified 3D model, and accelerate the solution of the electrical simulation of the 3D model.

Therefore, according to the selecting method of non-simplified region of 3D model of multilayer metal circuit structure provided by the present invention, it is used for selecting a first non-simplified region from a complete 3D model of a layout design of a multilayer metal circuit structure. The complete 3D model contains a plurality of layout layers. The selecting method of the first non-simplified region above includes at least one of the selecting modes described below.

A first selecting mode, comprising the steps of: searching a soldering pad group in a surface layer of the layout layers of the complete 3D model, said soldering pad group comprising a plurality of ground pads and at least one signal I/O pad; searching a predetermined number of the ground pads around a periphery of the at least one signal I/O pad by taking the at least one signal I/O pad as a center, and selecting an area enveloping the predetermined number of the ground pads and the at least one signal I/O pad as a first area; searching a layout layer having a grounding metal zone, which is located below said soldering pad group, wherein the ground pads of the soldering pad group are electrically connected to the grounding metal zone through a plurality of ground vias, the grounding metal zone further comprises one or more ground voids inside, and the ground vias are located on a periphery of the one or more ground void, selecting and enveloping a region having the one or more ground voids and a region having the predetermined number of the ground vias as a first region; and combining the first area and the first region as the first non-simplified region.

A second selecting mode, comprising the steps of: searching a soldering pad group in a surface layer of the layout layers of the complete 3D model, said soldering pad group comprising a plurality of ground pads and at least one signal I/O pad; searching a signal trace electrically connected to the at least one signal I/O pad and coplanar with the at least one signal I/O pad in the surface layer, and searching a signal via electrically connected to the signal trace in the layout layers, wherein the signal via passes through a M^{th} layer to a N^{th} layer in the layout layers, both M and N are positive integers and M is less than N; and in a range from a layer above the M^{th} layer to a next layer below the N^{th} layer in the layout layers, searching a predetermined number of said ground vias that are adjacent to the signal via layer by layer with the signal via as a center, then enveloping the predetermined number of the ground vias and the signal via as the first non-simplified region.

A third selecting mode, comprising the steps of: searching a layout layer having a signal trace and a first coplanar grounding metal zone on one side of the signal trace among the layout layers of the complete 3D model, the first coplanar grounding metal zone extending along the signal trace; dividing the signal trace into a plurality of signal trace units; taking each of the signal trace units as a center one by one, in an area of the first coplanar grounding metal zone, searching a layout layer having a first reference grounding zone and searching a predetermined number of first ground vias electrically connecting the first coplanar grounding metal zone and the first reference grounding zone layer by layer in the layout layers, enveloping the predetermined number of the first ground vias and each of the signal trace units as a first non-simplified region unit; combining the first non-simplified region unit and the signal trace in each layer of the layout layers, and selecting a region combining each of the first non-simplified region units and the signal trace as the first non-simplified region.

A fourth selecting mode, comprising the steps of: in the layout layers of the complete 3D model, searching a layout layer having a first grounding metal zone and a ground void inside the first grounding metal zone, a signal trace located on one side of the ground void, and a second grounding metal zone on located an opposite side of the ground void; searching a predetermined number of ground vias around a periphery of the ground void and electrically connecting the first grounding metal zone and the second grounding metal zone; enveloping the signal trace, the region around the ground void and containing the predetermined number of the ground vias, and the second grounding metal zone, selecting the enveloped region as the first non-simplified region.

By means of the one or more first non-simplified regions selected through the above-mentioned different selecting modes, these first non-simplified regions are regions that are greatly affected by high-speed signals during the transmission of high-speed signals in the multilayer metal circuit structure. Therefore, if the first non-simplified regions selected above retain their complete structure, the accuracy of electrical simulation can be maintained. On the other hand, replacing the regions other than the first non-simplified regions in the complete 3D model with metal structures will greatly simplify the 3D model of the multilayer metal circuit structure and shorten the overall electrical simulation time. Moreover, the present invention reproduces the human judgment of engineers in a programmed and automated manner. It can also greatly reduce the dependence on the electrical simulation experience of senior engineers.

In one aspect, in the second selecting mode, it is to select the one of the predetermined number of the ground vias that is farthest from the signal vias, and define the distance between the signal vias and the farthest ground via as a selecting radius, and then selecting the first non-simplified region according to the selecting radius.

In another aspect, in the above-mentioned third selecting mode, usually there are coplanar grounding metal zones on opposite sides of the signal trace. Therefore, the present invention also searches for such a second coplanar grounding metal zone on the other side of the signal trace relative to the first coplanar grounding metal zone, and such second coplanar grounding metal zone also extends along the signal traces. If there exists such second coplanar grounding metal zone, then searching a layout layer having a second reference grounding zone from the layout layers of the above-mentioned complete 3D model. Then, searching a predetermined number of second ground vias that are electrically connected to the second coplanar grounding metal zone and any one of the first or second reference grounding zone layer by layer in a range in accordance with the second coplanar grounding metal zone by taking each of the signal trace units as a center one by one, and then enveloping the predetermined number of regions of the first ground vias, regions of the second ground vias and each of the signal trace units as the first non-simplified region unit. Similarly, the first non-simplified region can be obtained by combining the above-mentioned multiple first non-simplified region units.

In another aspect, in the above-mentioned third selecting mode, selecting a virtual window with each signal trace unit as a center, enlarging the window to a first size, and determining whether the window covers the first ground vias in the first grounding metal zone; enlarging the window to a second size, and determining whether the window covers the second ground vias in the second coplanar grounding metal zone; defining a distance between the center of the window and the first ground via that is farthest from the center of the window to be a selecting radius, defining a distance between the center of the window and the second ground via that is farthest from the center of the window to be another selecting radius, and then selecting the first non-simplified region according to the two selecting radii.

The present invention also provides an automatic simplification mechanism of 3D model of multilayer metal circuit structure, which uses a computer to establish a complete 3D model based on a layout design of a multilayer metal circuit structure and simplifies the complete 3D model into a simplified 3D model. The complete 3D model comprises a plurality of layout layers. The automatic simplification mechanism comprises the steps of: selecting the first non-simplified region according to the selecting method of the first non-simplified region described above; obtaining at least one remaining non-simplified region according to a trace-to-trace isolation, a via-to-via isolation, or a via-to-trace isolation of the above-mentioned complete 3D model; enveloping the first non-simplified region and the at least one remaining non-simplified region as a closed region, defining the region other than the region that is enveloped as a simplified region, replacing the simplified region by a metal structure, and jointly establishing the simplified 3D model by the metal structure and the layout of the above-mentioned enveloped region.

In one aspect, in the step of obtaining the at least one remaining non-simplified region according to the trace-to-trace isolation, it further comprises the sub-steps of: searching a first signal trace, a second signal trace adjacent to the first signal trace, a plurality of first ground vias around a periphery of the first signal trace, and a plurality of second ground vias on a periphery of the second signal trace in the layout layers of the complete 3D model; dividing the first signal trace into a plurality of first signal trace units, and dividing the second signal trace into a plurality of second signal trace units; searching a first predetermined number of the first ground vias by taking each of the first signal trace units as a center one by one, and enveloping the first predetermined number of the first ground vias and the region corresponding to each of the first signal trace units to select a second non-simplified region unit, and searching a second predetermined number of the second ground vias by taking each of the second signal trace units as a center one by one, and enveloping the second predetermined number of the second ground vias and the region corresponding to each of the second signal trace units to select a third non-simplified region unit; and combining each of the second non-simplified region unit as a second non-simplified region, and combining each third non-simplified region unit as a third non-simplified region, and enveloping the second and third non-simplified regions as a closed region so as to obtain the remaining non-simplified region.

In another aspect, in the step of obtaining the at least one remaining non-simplified region according to the via-to-via isolation, it further comprises the sub-steps of: searching a first signal trace, a second signal trace adjacent to the first signal trace, a plurality of first ground vias around a periphery of the first signal trace, and a plurality of second signal vias around a periphery of the second signal trace in the layout layers of the complete 3D model; taking each of the first signal vias as a center one by one, determining whether any of the second signal vias exists within a first predetermined distance, if the determining result is true, defining a distance between the closest second signal via and the first signal via as a selecting radius, then selecting a fourth non-simplified region unit and combining each of the fourth non-simplified region units as a fourth non-simplified region; taking each of the second signal vias as a center one by one, determining whether any of the first signal vias exists within a predetermined distance, if the determining result is true, defining a distance between the closest first signal via and the second signal via as another selecting radius, then selecting a fifth non-simplified region unit and combining each of the fifth non-simplified region units as a fifth non-simplified region; enveloping the fourth and fifth non-simplified regions as a closed region to obtain the at least one remaining non-simplified region.

In another aspect, in the step of obtaining the at least one remaining non-simplified region according to the via-to-trace isolation, it further comprises the sub-steps of: in the layout layers of the complete 3D model, searching a plurality of signal aggressors and a signal trace adjacent to said signal aggressors; taking each of the signal aggressors as a center one by one, selecting a sixth non-simplified region unit according to a selecting radius, and the sixth non-simplified region unit covering a predetermined length of the signal trace; combining the sixth non-simplified region units as a sixth non-simplified region, and the above-mentioned sixth non-simplified region is thus the remaining non-simplified region.

The detailed steps and characteristics of the selecting method of the non-simplified region of the 3D model of the multilayer metal circuit structure and the automatic simplification mechanism of the 3D model will be described in the following embodiments. However, it should be understood that the embodiments and drawings described below are for illustrative purposes only, and should not be used for limiting the patent scope of the present invention, wherein:

### BRIEF DESCRIPTION OF THE DRAWINGS

FIG. 1 is a partial schematic view of the complete 3D model of the first embodiment.

FIG. 2 is similar to FIG. 1 and is used for illustrating multiple signal vias and ground vias.

FIG. 3 is a partial schematic diagram of the surface layer of the complete 3D model, used for illustrating the first selecting mode.

FIG. 4 is a partial schematic diagram of a layout layer below the surface layer of the complete 3D model, used for illustrating the first selecting mode.

FIG. 5 is a flow chart of the steps of the first selecting mode.

FIG. 6 is a partial schematic diagram of a layout layer of the complete 3D model, used for illustrating the second selecting mode.

FIG. 7 is a flow chart of the steps of the second selecting mode.

FIG. 8 is a partial schematic diagram of a layout layer of the complete 3D model, used for illustrating the third selecting mode.

FIG. 9 is a partial schematic diagram of a plurality of layout layers of a complete 3D model, used for illustrating the first and second reference grounding regions.

FIG. 10 is a flow chart of the steps of the third selecting mode.

FIG. 11 is a partial schematic diagram of a plurality of layout layers of a complete 3D model, used for illustrating the fourth selecting mode.

FIG. 12 is a flow chart of the steps of the fourth selecting mode.

FIG. 13 is a flow chart of the steps of the automatic simplification mechanism of the second embodiment.

FIG. 14 is a partial schematic diagram of a layout layer of a complete 3D model, used for illustrating the isolation of trace-to-trace.

FIG. 15 is another step flow chart, used for illustrating the sub-steps of step S5.2.

FIG. 16 is a partial schematic diagram of a layout layer of the complete 3D model, used for illustrating the isolation of via-to-via.

FIG. 17 is another step flow chart, used for illustrating the sub-steps of step S5.2.

FIG. 18 is a partial schematic diagram of a layout layer of the complete 3D model, used for illustrating the isolation of via-to-trace.

FIG. 19 is another step flow chart, used for illustrating the sub-steps of step S5.2.

FIG. 20 is a partial schematic diagram of the simplified 3D model.

FIG. 21 is a partial perspective cutaway view of FIG. 20.

### DETAILED DESCRIPTION OF THE INVENTION

In the embodiments described below, the terms of “region” (for example: non-simplified “region”) and “area” are used for referring to the 3D structure of a part of the complete 3D model of the multilayer metal circuit structure, and the terms “region” (e.g., grounding metal “region”), “area”, and “block” are used for referring to the two-dimensional structure (or the thickness of the structure is so thin, which is at least thinner than the thickness of one layer of layout layer, so that the structure can be deemed as “two-dimensional structure”) of a portion of a surface in a layout layer in a complete 3D model of a multilayer metal circuit structure.

The technical content and features of the present invention will be described in detail below by referring to several embodiments listed in conjunction with the drawings. The directional adjectives such as “upper”, “lower”, “inner”, “outer”, “top” and “bottom” mentioned in this specification are only illustrative descriptions based on the normal use direction, and are not intended to limit the scope of claims.

In addition, terms such as “first”, “second”, and “third” described in the following embodiments are only used for distinguishing descriptions, and should not be understood as indicating or implying relative importance.

In order to describe the technical features of the present invention in detail, the following two embodiments are given and described in conjunction with the drawings as follows, wherein:

The first embodiment illustrates a method for selecting the first non-simplified region of a 3D model of a multilayer metal circuit structure, which is used for selecting a first non-simplified region in a complete 3D model of a layout design of a multilayer metal circuit structure. In this embodiment, a computer capable of performing general functions is used for executing an electrical simulation software to carry out the modeling of the above-mentioned complete 3D model and the selection of the above-mentioned first non-simplified region. Electrical simulation software can, for example, use but not limited to ANSYS HFSS software for simulation. Usually, the layout design of a multi-layer metal circuit structure may have multiple layout layers, so the complete 3D model after establishment may also have multiple layout layers. Each layout layer may contain soldering pads (on the surface layer), ground metal zones, signal vias, ground vias, ground voids and signal traces, or a combination of one or more of the above-mentioned structures. according to different layout designs.

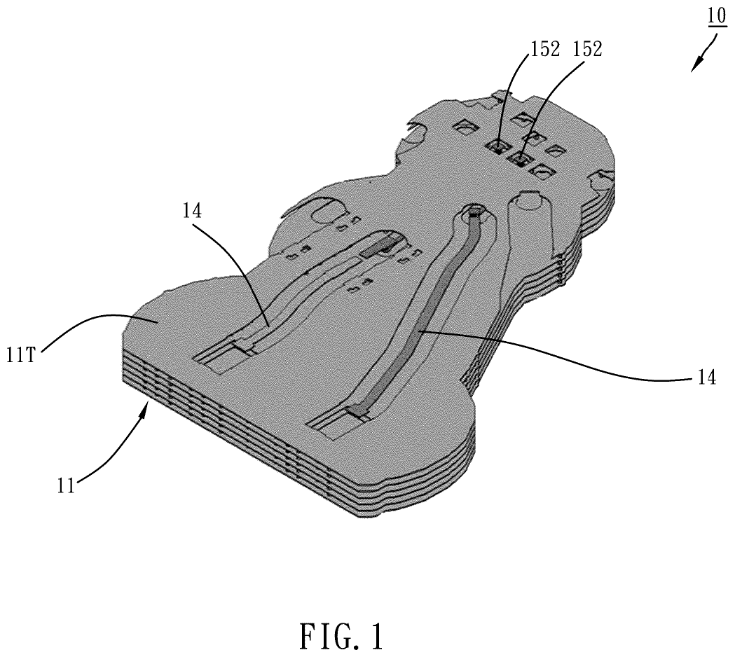

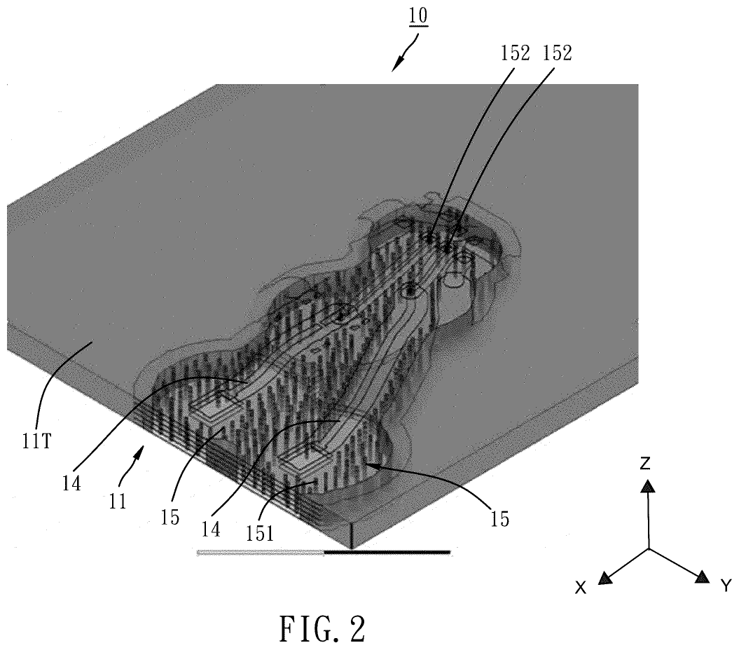

Please refer to FIG. 1 and FIG. 2. FIG. 1 shows the partial structure of the complete 3D model 10 after establishment, and it shows 6 layout layers 11 of the complete 3D model 10, wherein, in the uppermost layout layer 11 (that is, the surface layer 11T), at least two signal traces 14 and a plurality of vias 15 passing through the surface layer 11T are shown. Via 15 can be a ground via 151 (see FIG. 2) or a signal via 152 (see FIG. 1 and FIG. 2). As shown in FIG. 1 and FIG. 2, if all vias 15 are displayed, the displayed result is shown in FIG. 2, which is a very detailed and complex model. If the complete 3D model 10 shown in FIG. 1 and FIG. 2 is directly subjected to electrical simulation without appropriate simplification, it will take a lot of time to calculate and solve the electrical simulation. The selecting method of the first non-simplified region described in the first embodiment is selected by at least one or more of the following selecting modes, which are respectively described as follows:

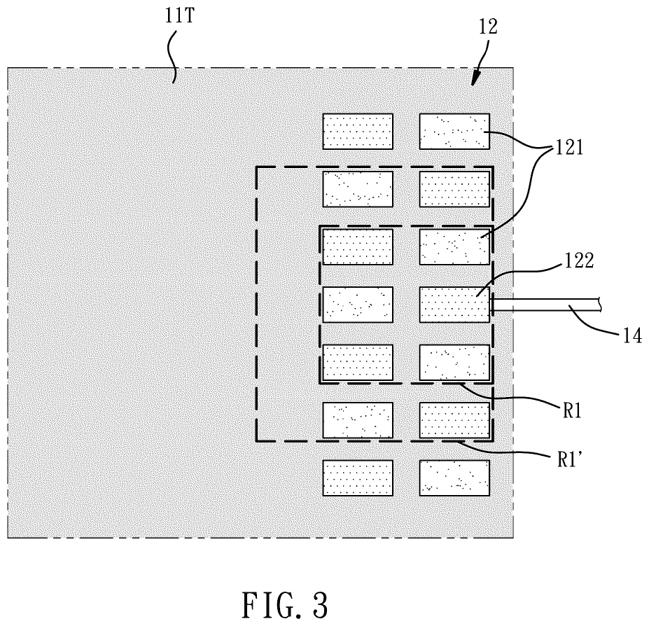

The first selecting mode: please refer to FIG. 3 to FIG. 5, the first selecting mode includes the following steps.

Step S1.1: As shown in FIG. 3, it shows the partial structure of a surface layer 11T in the layout layers 11 in the complete 3D model 10. The above-mentioned surface layer 11T is the uppermost layer among the layout layers 11 in this embodiment, and in some cases, the above surface layer 11T may also be the bottommost layer among the layout layers 11. First, searching a soldering pad group 12 on the surface layer 11T in the layout layers 11 of the complete 3D model 10. The soldering pad group 12 is used for soldering different pins of a chip in this embodiment. The soldering pad group 12 includes a plurality of ground pads 121 and a plurality of signal input and output pads 122 (Signal I/O Pad).

Step S1.2: Take one of the signal I/O pads 122 as the center, search for a predetermined number of the ground pads 121 on the periphery of the signal I/O pad 122, and select an area enveloping the predetermined number of the ground pads 121 and the signal I/O pads 122 as a first area R1. In this embodiment, the signal I/O pad 122 connected to a signal trace 14 is selected as the center. To improve the accuracy of electrical simulation, or to more accurately simulate the isolation between high-speed signals, more predetermined numbers of ground pads will be included to consider the energy distribution of wider high-speed signals. In some cases, enlarge the selected first area R1 by a predetermined times to an enlarged first area R1′ depending on the size of the 3D metal circuit structure of the product to be simulated (such as a small package substrate or a mobile phone motherboard, or a larger server motherboard).

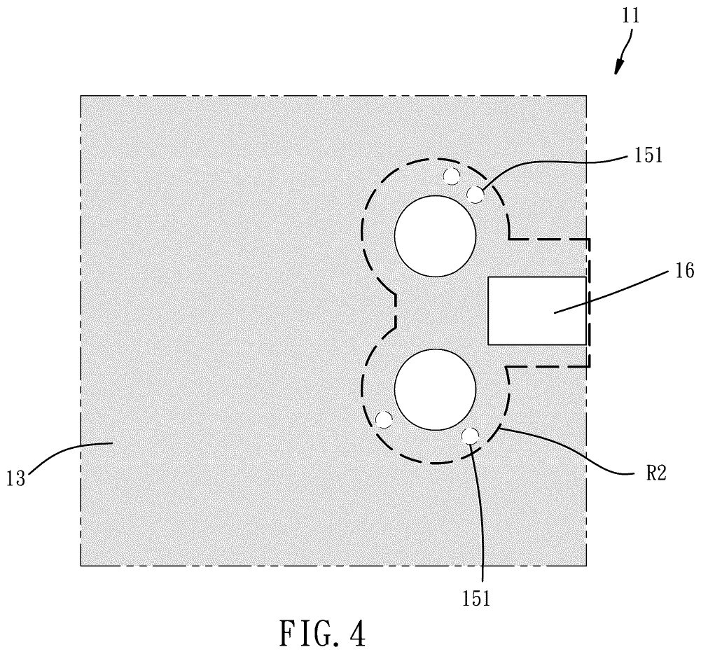

Step S1.3: In the layout layers 11 of the complete 3D model 10, searching a layout layer 11 having a grounding metal zone 13 that is located below the soldering pad group 12 (as shown in FIG. 4). Most of the surface of the above-mentioned layout layer 11 is provided with the above-mentioned grounding metal zone 13 (made of copper), and each of the ground pads 121 of the surface layer 11T is electrically connected to the grounding metal zone 13 through one or more ground vias 151. The interior of the grounding metal zone 13 is provided with a ground void 16 corresponding to the position of the soldering pad group 12 of the surface layer 11T, and the ground void 16 runs through the layout layer 11, so as to reduce the capacitive effect between the surface layer 11T and the layout layer 11. After that, select and envelop the region with the one or more ground voids 16 (the range of the enveloped region extends to the bottom of the ground voids 16; if the number of ground voids is one, only select the region of the only one ground void) and the region with a predetermined number of the ground vias 151 as a first region R2.

Step S1.4: Combine the enlarged first area R1′ and first region R2 as the first non-simplified region.

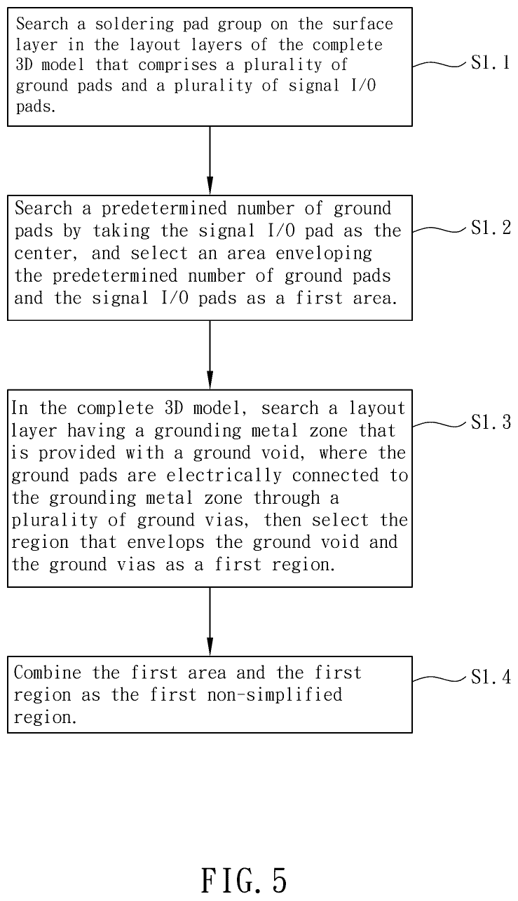

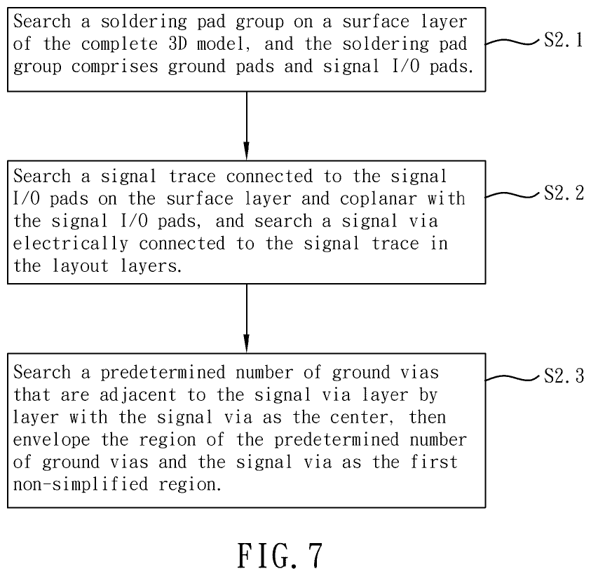

The second selecting mode: please refer to FIG. 5 to FIG. 7, the second selecting mode includes the following steps.

Step 2.1: As shown in FIG. 3, search for a soldering pad group 12 on a surface layer 11T of the layout layers 11 of the complete 3D model 10, and the soldering pad group 12 includes a plurality of ground pads 121 and a plurality of signal I/O pads 122.

Step 2.2: searching a signal trace 14 connected to the signal I/O pads 122 on the surface layer 11T and coplanar with the signal I/O pads 122, and searching a signal via 22 electrically connected to the signal trace 14 in the layout layers 11, wherein the definition of the signal via 22 is through the layout layers 11 from the M^{th} layer to the N^{th} layer in the layout layers 11 counted from top to bottom, M and N are both positive integers and M is less than N. In this embodiment, the signal via 22 is directly electrically connected to the signal trace 14, and it is taken as an example that the signal via 22 penetrates the 3^{rd} layer to the 6^{th} layer of the layout layers 11.

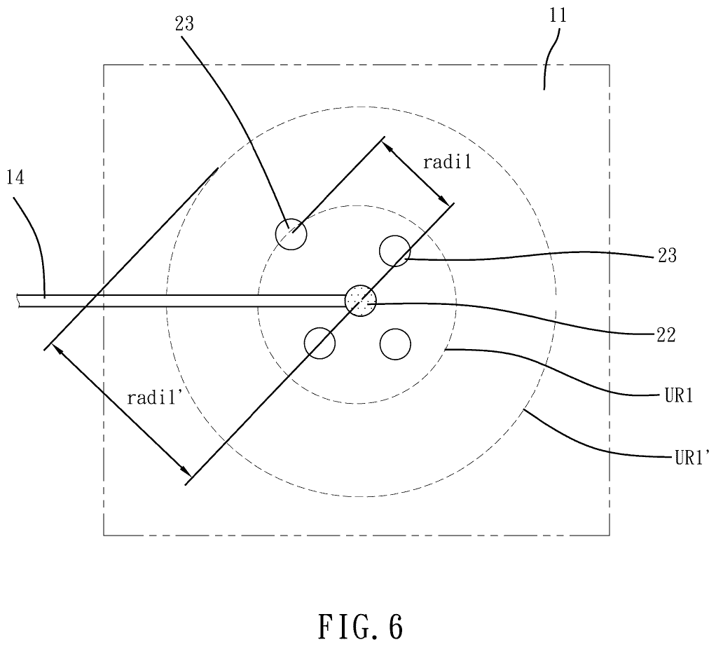

Step 2.3: In the range from the layer above the M^{th} layer to the next layer of the N^{th} layer among the layout layers 11, searching a predetermined number of ground vias 23 that are relatively adjacent to the signal via 22 layer by layer with the signal via 22 as the center. In this embodiment, one or more ground vias 23 that are relatively adjacent to the signal via 22 are searched within the range from the 2^{nd} layer to the 7th layer of the layout layers 11, as shown in FIG. 6, there are in total four ground vias 23 relatively adjacent to the signal via 22. After that, the region that can envelope the predetermined number of ground vias 23 and the signal via 22 is defined to be the first non-simplified region UR1. Likewise, in some cases, enlarge the first non-simplified region UR1 by a predetermined times to an enlarged first non-simplified region UR1′ depending on the size of the 3D metal circuit structure of the product to be simulated (such as a small package substrate or a mobile phone motherboard, or a larger server motherboard). In this embodiment, select the farthest one from the signal via 22 among the ground vias 23, and define the distance between the signal via 22 and the farthest ground via 23 as a selecting radius radi1, then enlarge the selecting radius radi1 to an enlarged selecting radius radi1′ with a predetermined times (for example, enlarged into two times), and then select the enlarged first non-simplified region UR1′ according to the range enveloped by the enlarged selecting radius radi1′ (including the range of the layout layers 11 from the layer above the M^{th} layer to the next layer of the N^{th} layer).

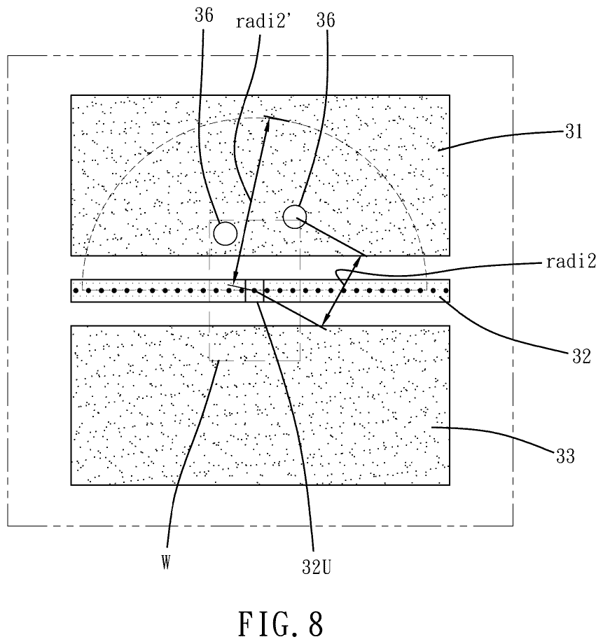

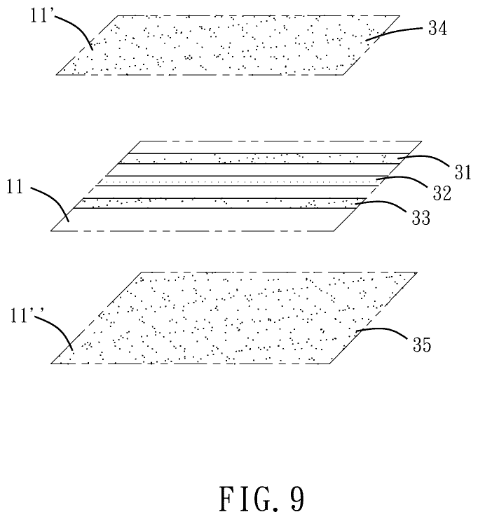

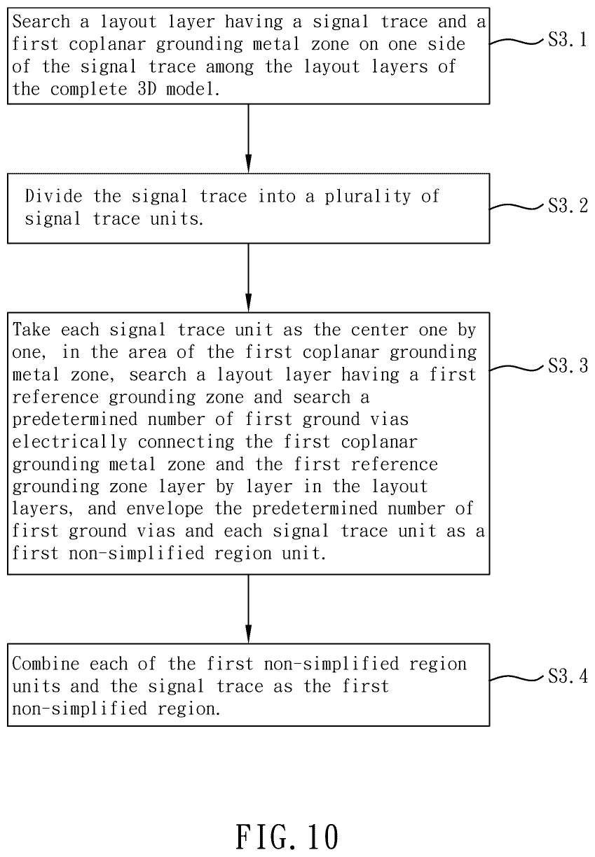

The third selecting mode: please refer to FIG. 8 to FIG. 10, the third selecting mode includes the following steps.

Step 3.1: In the layout layers 11 of the complete 3D model 10, searching a layout layer 11 having a signal trace 32 and a first coplanar grounding metal zone 31 on one side of the signal trace 32. The first coplanar grounding metal zone 31 extends along the signal trace 32 in a manner parallel to the signal trace 32. Usually, in the layout design of a multilayer metal circuit structure involving radio frequency signals, a second coplanar grounding metal zone 33 is also provided on the other side of the signal trace 32 relative to the first coplanar grounding metal zone 31, therefore, the second coplanar grounding metal zone 33 is also searched during the simulation process, and the second coplanar grounding metal zone 33 also extends along the signal trace 32 in a manner parallel to the signal trace 32. It is worth noting that the above-mentioned layout layer 11 having the structure of the first and second coplanar grounding metal zones 31, 33 and signal trace 32 is not necessarily located on the surface layer 11T of the multilayer metal circuit structure.

Step 3.2: Divide the signal trace 32 into a plurality of signal trace units 32U.

Step 3.3: Taking each one of the signal trace units 32U as the center one by one, within the region where the area of the first coplanar grounding metal zone 31 vertically extended, searching a layout layer 11′ located above the layout layer 11 and having a first reference grounding zone 34 and a layout layer 11″ located below the layout layer 11 and having a second reference grounding zone 35 layer by layer in the layout layers, and searching a predetermined number of first ground vias 36 that is electrically connecting the first coplanar grounding metal zone 31 and the first reference grounding zone 34 and a plurality of first ground vias 36 that is electrically connecting the first coplanar grounding metal zone 31 and the second reference grounding zone 35 layer by layer in the layout layers. If there exists a second coplanar grounding metal zone 33, also taking each of the signal trace units 32U as the center one by one, searching a predetermined number of second ground vias electrically connecting the second coplanar grounding metal zone 33 and electrically connecting the first and second reference grounding zones 34, 35 layer by layer in the layout layers of the complete 3D model 10 (in this embodiment, there is no second ground via in the area of second coplanar grounding metal zone 33).

Normally, a virtual window W may be selected with each signal trace unit 32U as the center, enlarge the window W to a first size in equal proportions, and judge whether the window W covers the first ground vias 36 in the area of the first grounding metal zone 31. If there exists a second coplanar grounding metal zone 33, the above-mentioned window W is also proportionally enlarged to a second size (the second size may be greater than, equal to or smaller than the first size), and judge whether the window W covers the second ground vias in the area of the second coplanar grounding metal zone 33. For example, as shown in FIG. 8, with the window W as the center, when enlarged to a first size, the window W covers two first ground vias 36 whose predetermined number is two. At this time, the distance between the center of the window W and the farthest first ground via 36 is defined as a selecting radius radi2, envelop in a semicircle and select the area of the first ground vias 36 and the signal trace unit 32U as a first non-simplified region unit. In some cases, it is also possible to expand to the enlarged selecting radius radi2′ at a specified times, and then take the center of the window W as the center, and select the first non-simplified region unit in a semicircle with the expanded selecting radius radi2′ as the radius.

On the other hand, in this embodiment, since the size of the window W is enlarged, any second ground via is still not covered in the area of the second coplanar grounding metal zone 33, in this way, all the area covered by the window W in the second coplanar grounding metal zone 33 are combined with the range of the first ground vias 36 and the signal trace units 32U after the above envelope as the first non-simplified region unit. Conversely, assuming that when the size of the window W is enlarged, the first coplanar grounding metal zone 31 does not cover any first ground via and the second coplanar grounding metal zone 33 covers the second ground vias, in this way, all the area of the first coplanar grounding metal zone 31 will be retained, and the abovementioned area will be combined as the first non-simplified region unit.

Step 3.4: after obtaining each of the first non-simplified region units during the step 3.4, combine each of the first non-simplified region unit and the signal trace 32 in the layout layers 11, 11′, 11″, and select the region of the combined each of the first non-simplified region unit and the signal trace 32 as the first non-simplified region UR1.

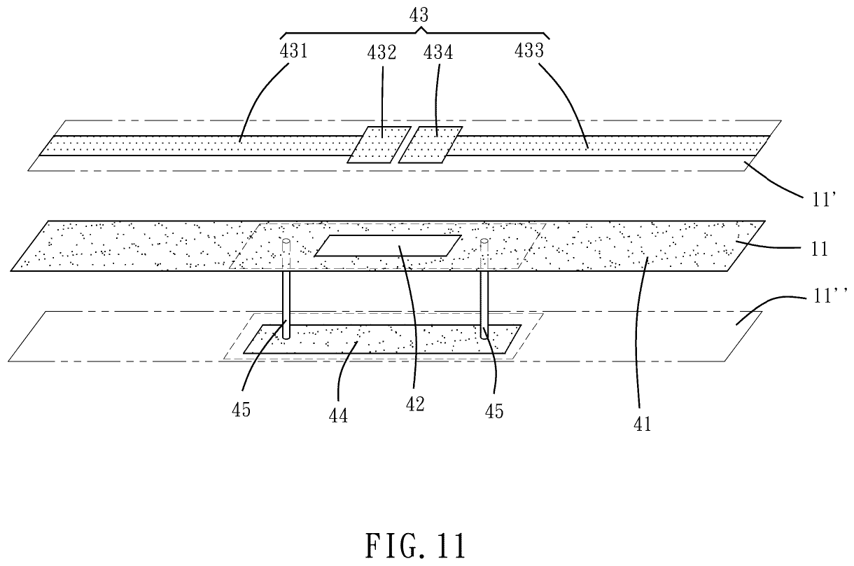

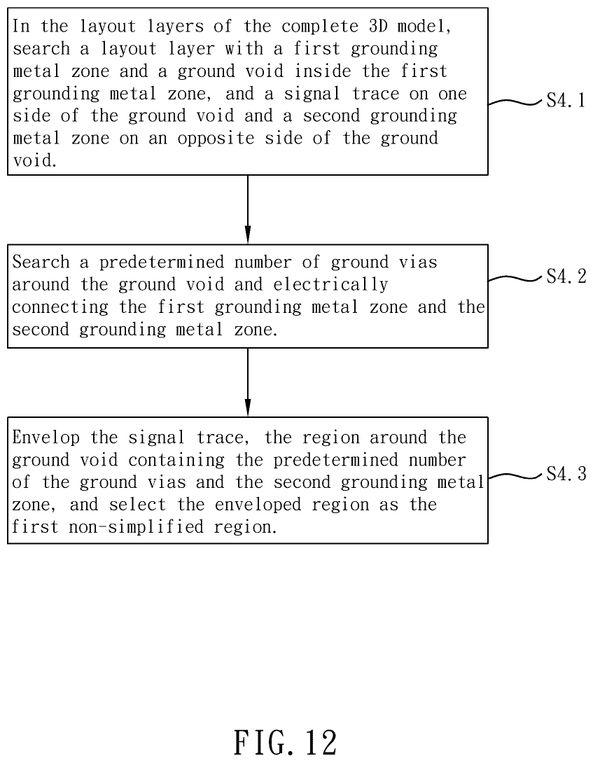

The fourth selecting mode: please refer to FIG. 11 and FIG. 12, the fourth selecting mode includes the following steps.

Step S4.1: In the layout layers 11 of the complete 3D model 10, searching a layout layer 11 having a first grounding metal zone 41 and a ground void 42 inside the first grounding metal zone 41, a signal trace 43 located on one side of the ground void 42, and a second grounding metal zone 44 located on the other side of the ground void 42. In this embodiment, the layout layer 11′ with the signal trace 43 is located above the layout layer 11 having the first grounding metal zone 41 and ground void 42, and the layout layer 11″ with the second grounding metal zone 44 is located below the layout layer 11. The signal trace 43 includes a first signal trace unit 431, a second signal trace unit 433, a first metal block 432 connected to the first signal trace unit 431, and a second metal block 434 connected to the second signal trace unit 433 and spaced apart from the first metal block 432. The first and second metal blocks 432, 434 are located directly above the ground void 42.

Step S4.2: searching a predetermined number of ground vias 45 around the ground void 42 and electrically connect the first grounding metal zone 41 and the second grounding metal zone 44.

Step S4.3: Envelop the area of the surrounding of the above-mentioned signal trace 43 and the ground void 42 that contains the above-mentioned predetermined number of ground vias 45 and the region of the second grounding metal zone 44, and select the region after the above-mentioned envelope as the first non-simplified region UR1.

After the selection of the one or more first non-simplified regions UR1 by the above different selecting modes, the regions other than the one or more first non-simplified regions UR1 selected above can be replaced by metal structures M. In this way, the complete 3D model 10 of the multilayer metal circuit structure can be greatly simplified, thereby shortening the overall electrical simulation time.

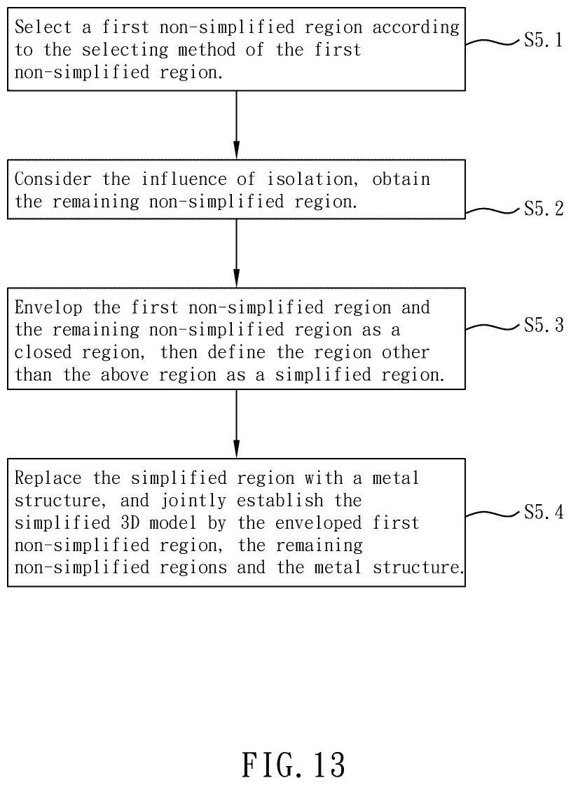

Through the abovementioned four selecting modes, it has been possible to simplify the complete 3D model 10 for electrical simulation while maintaining a certain degree of accuracy. But if considering further improve the accuracy of electrical simulation, the engineer may further consider the influence of isolation. The influence of isolation can be divided into the following three situations: Considering the isolation of trace-to-trace, considering the isolation of via-to-via, and considering the isolation of via-to-trace. Therefore, the following second embodiment will further illustrate an automatic simplification mechanism of a complete 3D model of a multilayer metal circuit structure. It also uses a computer to build a complete 3D model 10 based on the layout design of a multilayer metal circuit structure and simplify the above-mentioned complete 3D model 10 into a simplified 3D model 10′. The above-mentioned complete 3D model 10 includes multiple layout layers 11. Please refer to FIG. 13, the above-mentioned automatic simplification mechanism includes the following steps:

Step S5.1: Select a first non-simplified region UR1 according to the method for selecting the first non-simplified region in the above embodiment. It should be noted that, depending on different layout design of the multilayer metal circuit structure, the selected first non-simplified region UR1 may have one or more regions.

Step S5.2: Considering the influence of the isolation, obtaining at least one remaining non-simplified region, which are respectively described as follows:

### A: Considering the Isolation of Trace-to-Trace:

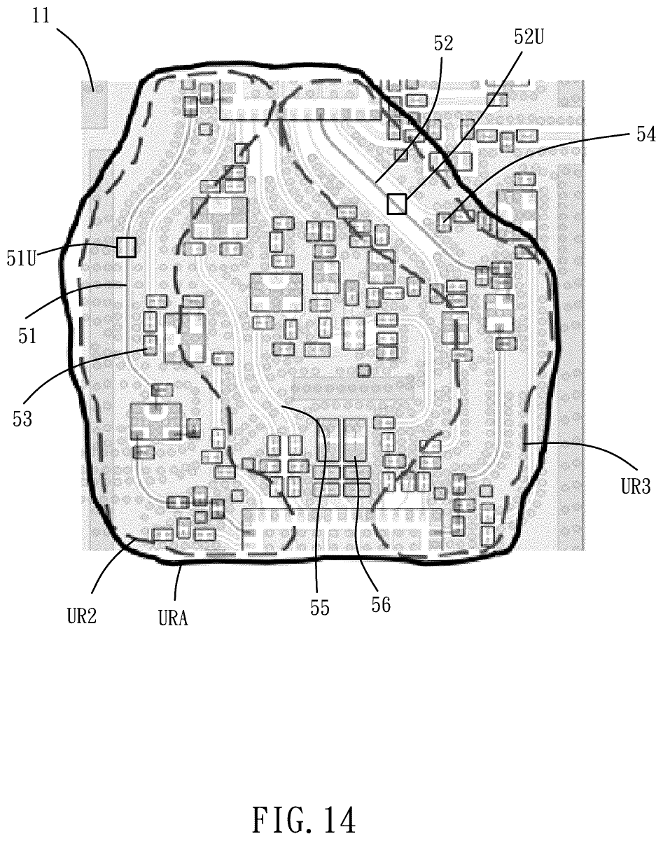

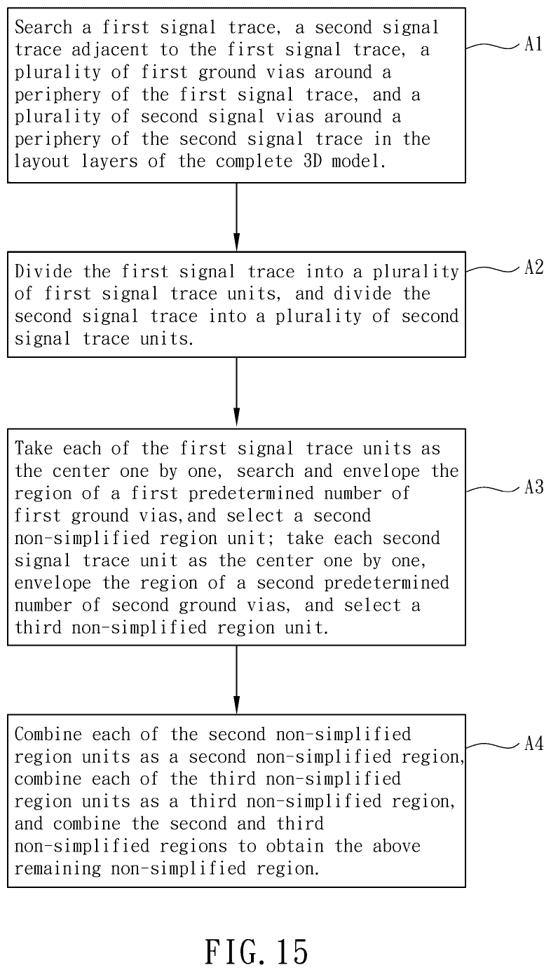

If considering the influence of trace-to-trace isolation, step S5.2 can also be divided into the following sub-steps, please refer to FIG. 14 and FIG. 15.

Sub-step A1: In the layout layers 11 of the complete 3D model 10, searching a first signal trace 51, a second signal trace 52 adjacent to the first signal trace 51, a plurality of first ground vias 53 located on the periphery of and adjacent to the first signal trace 51 and a plurality of second ground vias 54 located on the periphery of and adjacent to the second signal trace 52. As shown in FIG. 14, in one of the layout layers 11, the first signal trace 51 is located on the left side of the layout layer 11, and the second signal trace 52 is located on the right side of the layout layer 11, and there are also several traces 55 and vias 56 between the first signal trace 51 and the second signal trace 52.

Sub-step A2: Dividing the first signal trace 51 into a plurality of first signal trace units 51U, and dividing the second signal trace 52 into a plurality of second signal trace units 52U.

Sub-step A3: Taking each of the first signal trace units 51U as the center one by one, searching a first predetermined number of the first ground vias 53 and enveloping the above-mentioned first predetermined number of the first ground vias 53 and the region corresponding to each of the first signal trace units 51U to select a second non-simplified region unit. Similarly, taking each of the second signal trace units 52U as the center one by one, searching a second predetermined number of the second ground vias 54 and enveloping the above-mentioned second predetermined number of the second ground vias 54 and the region corresponding to each of the second signal trace units 52U to select a third non-simplified region unit.

Sub-step A4: Combining each of the second non-simplified region units as a second non-simplified region UR2, and combining each of the third non-simplified region units as a third non-simplified region UR3, and enveloping the second and third non-simplified regions UR2, UR3 as a closed region so as to obtain the remaining non-simplified region URA.

### B: Considering the Isolation of Via-to-Via:

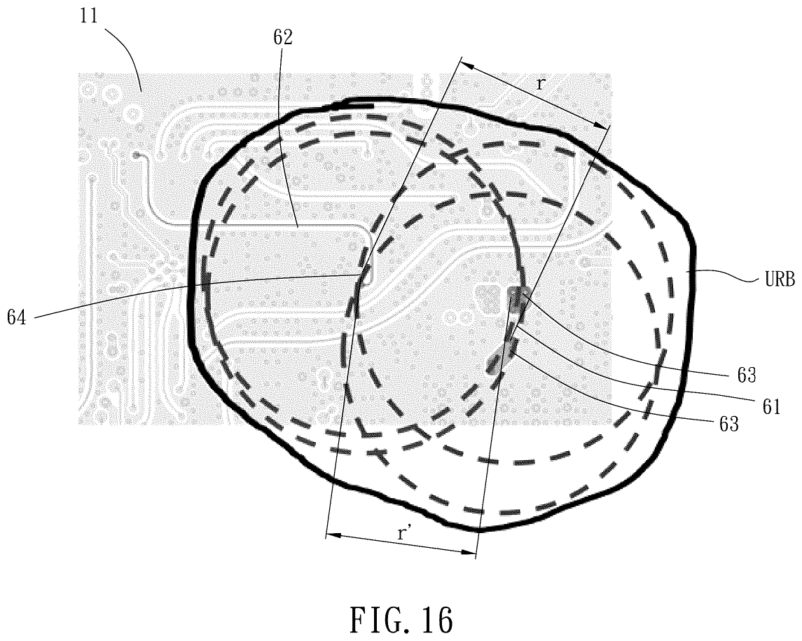

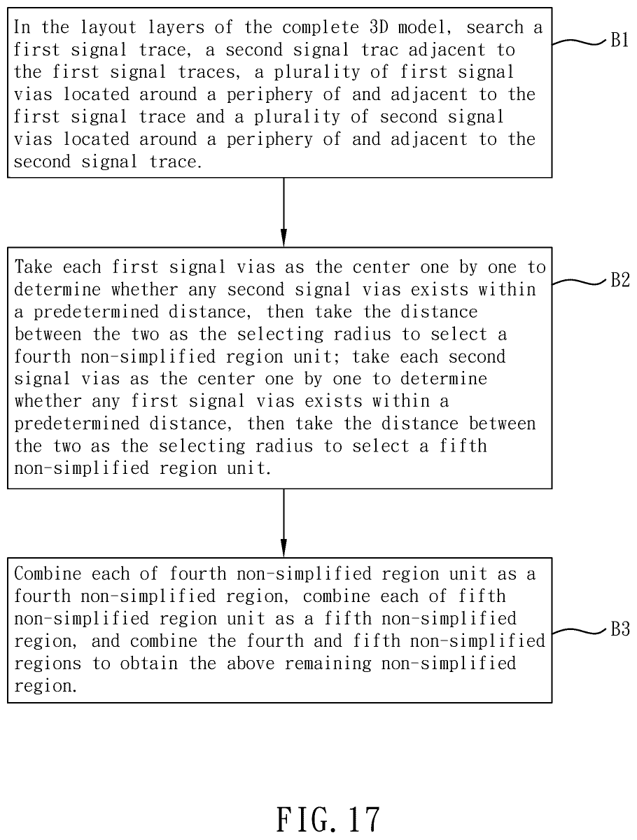

If considering the influence of via-to-via isolation, step S5.2 may be divided into the following sub-steps, please refer to FIG. 16 and FIG. 17.

Sub-step B1: Similarly, in the layout layers 11 of the complete 3D model 10, searching a first signal trace 61, a second signal trace 62 adjacent to the first signal traces 61, a plurality of first signal vias 63 located on the periphery of and adjacent to the first signal trace 61 and a plurality of second signal vias 64 located on the periphery of and adjacent to the second signal trace 62. In this embodiment, the number of the first signal vias 63 is two. The two first signal vias 63 are located at opposite ends of the first signal trace 61, and the first signal trace 61 is located on an inner layer in the layout layers 11. It should be noted that, in some cases, the first signal trace 61 and the two first signal vias 63 may be located on the same layer.

Sub-step B2: Taking each of the first signal vias 63 of the first signal trace 61 as the center one by one, determining whether any of the second signal vias 64 exists within a first predetermined distance. If the determination result is true, selecting a fourth non-simplified region unit in accordance with a selecting radius radi3 defined by the distance between the closest second signal via 64 and the first signal via 63. In some cases, the selecting radius radi3 may be enlarged by adding an enlarged retention distance as an enlarged selecting radius and use the enlarged selecting radius to select the fourth non-simplified region unit. Combining each of the fourth non-simplified region units as a fourth non-simplified region. As shown in FIG. 16, a second signal via 64 can be found within the first predetermined distance from the first signal via 63, therefore, the fourth non-simplified region unit is enveloped by taking the distance between the first signal via 63 and the closest second signal via 64 as the selecting radius radi3.

In addition, taking each of the second signal vias 64 of the second signal trace 62 as the center one by one, determining whether any of the first signal vias 63 exists within a second predetermined distance. If the determination result is true, selecting the distance between the closest first signal via 63 and the second signal via 64 as another selecting radius radi3′ (It may be enlarged by adding an enlarged retention distance to be another enlarged selecting radius), selecting a fifth non-simplified region unit, and then combining each of the fifth non-simplified region units as a fifth non-simplified region.

Sub-step B4: Combine each fourth non-simplified region unit as a fourth non-simplified region, and combine each fifth non-simplified region unit as a fifth non-simplified region, and envelope the fourth and fifth non-simplified regions as a closed region and obtain the remaining non-simplified region URB.

### C: Considering Influence of the Isolation of Via-to-Trace:

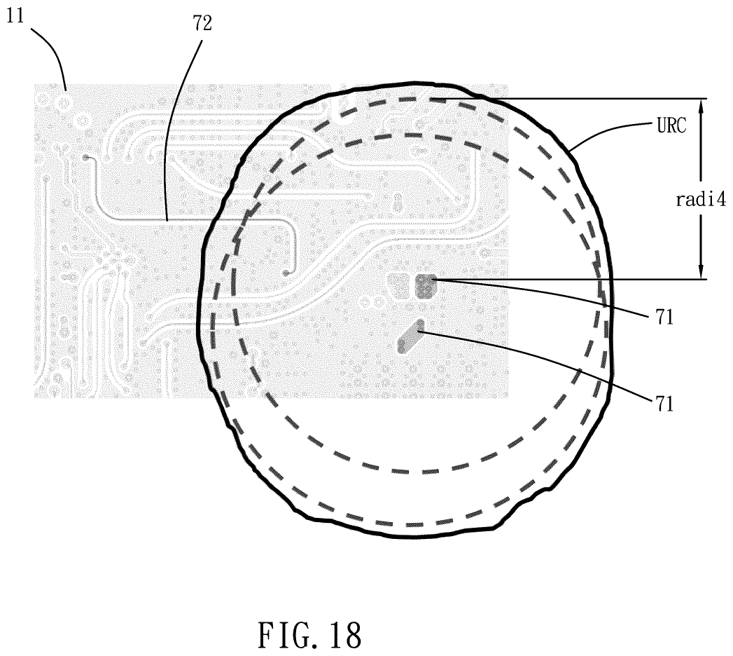

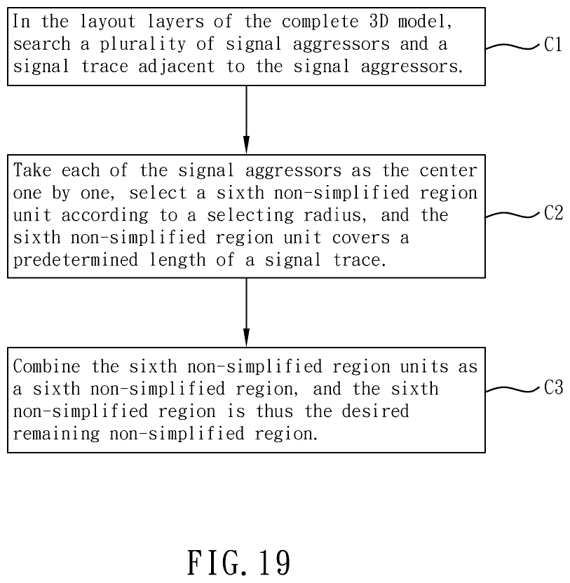

If considering the influence of via-to-trace isolation, step S5.2 may be divided into the following sub-steps, please refer to FIG. 18 and FIG. 19.

Sub-step C1: Similarly, in the layout layers 11 of the complete 3D model 10, searching a plurality of signal aggressors 71 and a signal trace 72 adjacent to the signal aggressors 71. In this embodiment, each of the signal aggressors 71 is essentially a signal via.

Sub-step C2: Taking each of the signal aggressors 71 as the center one by one, and selecting a sixth non-simplified region unit according to a selecting radius radi4, the above-mentioned sixth non-simplified region unit covers a predetermined length of the signal trace 72.

Sub-step C3: combining each of the sixth non-simplified region units as a sixth non-simplified region, and the sixth non-simplified region is thus the desired remaining non-simplified region URC.

In the step S5.2, different remaining non-simplified regions URA-URC are obtained according to the consideration of the isolations of different situations, and then the following steps are performed.

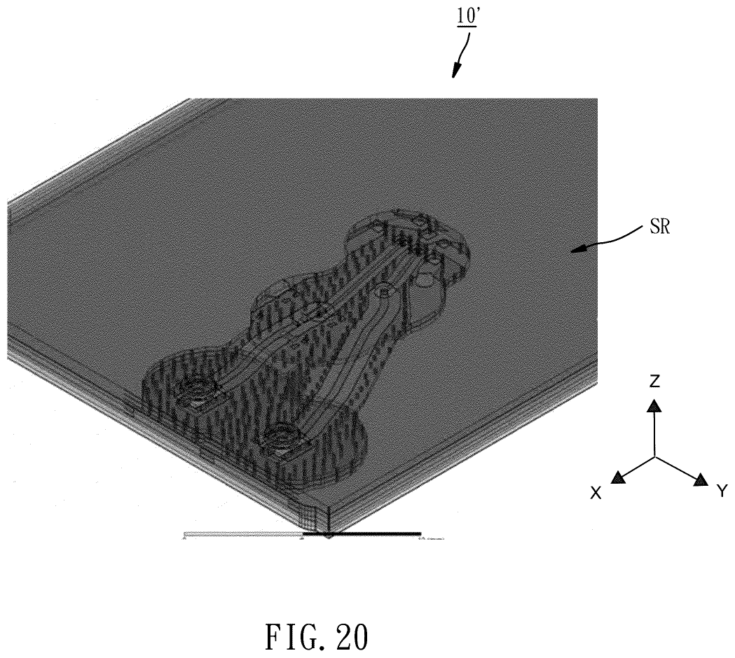

Step S5.3: Enveloping the first non-simplified region UR1 and the remaining non-simplified regions URA-URC into a closed region. For example, if the influence of trace-to-trace isolation is considered, enveloping the first to third non-simplified regions into a closed region; if the influence of trace-to-trace isolation and via-to-via isolation are considered at the same time, enveloping the first to fifth non-simplified regions into a closed region; if the influence of trace-to-trace isolation and via-to-trace isolation are considered at the same time, enveloping the first to the third, the sixth to the seventh non-simplified regions into a closed region, and the rest of the situations can be deduced like this. Afterwards, defining the region other than the enveloped regions of the first non-simplified region UR1 and the at least one remaining non-simplified region URA-URC as a simplified region SR (as shown in FIG. 20).

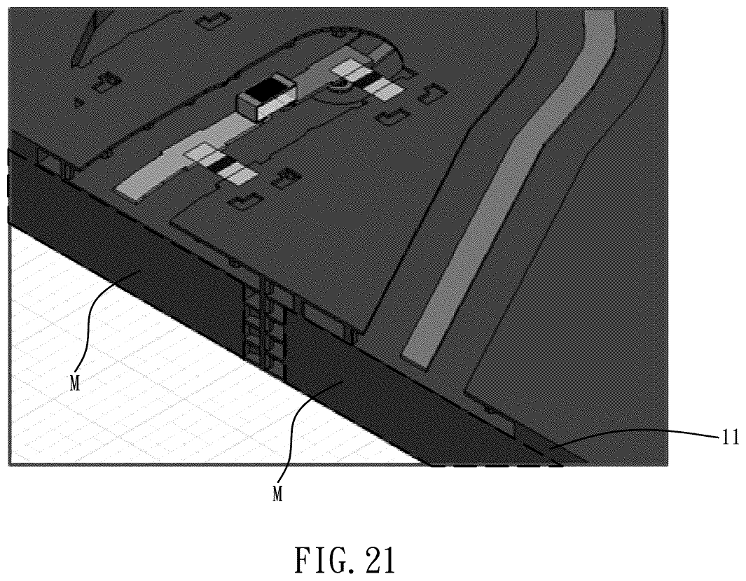

Step S5.4: replacing the simplified region SR defined in step S5.3 by a metal structure M (as shown in FIG. 21), such as a solid structure formed by pure copper. In this way, the desired simplified 3D model 10′ can be jointly established by the above-mentioned metal structure M and the layout of the enveloped first non-simplified region UR1 and the rest non-simplified region URA-URC. The simplified 3D model 10′ can be shown in FIG. 20 and FIG. 21. In FIG. 20, it can be seen that compared with FIG. 2, most via structures have been replaced by the metal structure M. In FIG. 21, it can be seen that the region of the partial structure of the multiple layout layers 11 has been replaced by the metal structure M.

It should be noted that if the simplified region SR is replaced by the solid metal structure M, the result after the replacement will be similar to the structure of the original multilayer metal circuit structure covered with a large area of copper foil before any layout is performed, it is also true that it will less affect the accuracy of electrical simulation.

The inventor has actually done actual electrical simulation tests. Taking the layout design of a multilayer metal circuit structure with a 4-channel Wi-Fi module as an example, through the automatic simplification mechanism of this embodiment, the electrical simulation time can be reduced to 12 hours. Taking the layout design of a multilayer metal circuit structure with 22 channels of 4G LTE high-speed signals as an example, the electrical simulation time can be reduced to 48 hours. If the simplification mechanism of this embodiment is not used for simplifying the complete 3D model, the time for electrical simulation will be estimated to be 3 to 5 times the time required for electrical simulation after simplification. It can be seen that this embodiment can indeed greatly reduce the overall electrical simulation time, and because the electrical simulation time may be compressed to within 2 days, the electrical simulation schedule can also meet the needs of the industry. Moreover, performing the electrical simulation in a programed way can also reduce the dependence on the electrical simulation experience of senior engineers.

It should be noted that the problem to be dealt with by the present invention is mainly the design of multilayer metal circuit structures for high-speed signals. The selected non-simplified regions are mainly the regions that are easily affected by the current of high-speed signals. The selecting methods are quite systematic and scientific, and can effectively improve the efficiency of electrical simulation, all of which are the main points of the present invention.

Finally, it must be stated again that the methods and components disclosed in the foregoing embodiments of the present invention are only for illustration and are not intended to limit the patent scope of the present invention. Any simple structural modifications or changes made without departing from the spirit of the present invention, or replacements with other equivalent elements, should still fall within the scope of the patent application for the present invention.

What is claimed is:

1. A selecting method of non-simplified region of 3D model of multilayer metal circuit structure, which is used for selecting a first non-simplified region from a complete 3D model of a layout design of a multilayer metal circuit structure, said complete 3D model containing a plurality of layout layers, the selecting method of said first non-simplified region comprising at least one of the following selecting modes:
a first selecting mode, comprising the steps of:
searching a soldering pad group in a surface layer of said layout layers of said complete 3D model, said soldering pad group comprising a plurality of ground pads and at least one signal I/O pad;
searching a predetermined number of said ground pads around a periphery of said at least one signal I/O pad by taking said at least one signal I/O pad as a center, and selecting an area enveloping said predetermined number of said ground pads and said at least one signal I/O pad as a first area;
searching a layout layer having a grounding metal zone, which is located below said soldering pad group, in said layout layers of said complete 3D model; said ground pads of said soldering pad group are electrically connected to said grounding metal zone through a plurality of ground vias; said grounding metal zone further comprising at least one ground void inside; said ground vias are located around a periphery of said at least one ground void; selecting and enveloping a region having said at least one ground void and a region having said predetermined number of said ground vias as a first region; and
combining said first area and said first region as said first non-simplified region;
a second selecting mode, comprising the steps of:
searching a soldering pad group in a surface layer of said layout layers of said complete 3D model, said soldering pad group comprising a plurality of ground pads and at least one signal I/O pad;
searching a signal trace electrically connected to said at least one signal I/O pad and coplanar with said at least one signal I/O pad in said surface layer, and searching a signal via electrically connected to the signal trace in said layout layers, wherein said signal via passes through a M^{th} layer to a N^{th} layer in said layout layers, and both of M and N are positive integers and M is less than N; and
in a range from a layer above the M^{th} layer to a next layer below the N^{th} layer in said layout layers, searching a predetermined number of said ground vias that are adjacent to said signal via layer by layer with said signal via as a center, then enveloping the predetermined number of said ground vias and said signal via as said first non-simplified region;
a third selecting mode, comprising the steps of:
searching a layout layer having a signal trace and a first coplanar grounding metal zone on one side of said signal trace in said layout layers of said complete 3D model, said first coplanar grounding metal zone extending along said signal trace;
dividing said signal trace into a plurality of signal trace units;
taking each of said signal trace units as a center one by one, in an area of said first coplanar grounding metal zone, searching a layout layer having a first reference grounding zone and searching a predetermined number of first ground vias electrically connecting said first coplanar grounding metal zone and said first reference grounding zone layer by layer in said layout layers, enveloping said predetermined number of said first ground vias and each of said signal trace units as a first non-simplified region unit; and
combining each of said first non-simplified region units and said signal trace in each layer of said layout layers, and selecting a region combining each of said first non-simplified region units and said signal trace as said first non-simplified region;
a fourth selecting mode, comprising the steps of:
in said layout layers of said complete 3D model, searching a layout layer having a first grounding metal zone, a ground void inside said first grounding metal zone, a signal trace located on one side of said ground void, and a second grounding metal zone located on an opposite side of said ground void;
searching a predetermined number of ground vias around said ground void and electrically connecting said first grounding metal zone and said second grounding metal zone; and
enveloping said signal trace, a region around said ground void containing said predetermined number of said ground vias, and said second grounding metal zone, selecting the enveloped region as the first non-simplified region.

2. The selecting method of first non-simplified region as claimed in claim 1, wherein in said second selecting mode, selecting one of the ground vias among said predetermined number of said ground vias that is the farthest from said signal via, defining a distance between said signal via and said ground via that is the farthest from said signal via as a selecting radius, and selecting said first non-simplified region according to said selecting radius.

3. The selecting method of said first non-simplified region as claimed in claim 1, wherein in said third selecting mode, further searching a second coplanar grounding metal zone that is located on an opposite side of said signal trace relative to said first coplanar grounding metal zone, and said second coplanar grounding metal zone extends along said signal trace;
wherein, further searching a layout layer having a second reference grounding zone among said layout layers of said complete 3D model;
searching a predetermined number of second ground vias that are electrically connected to said second coplanar grounding metal zone and any one of said first or second reference grounding zones layer by layer in a range in accordance with said second coplanar grounding metal zone by taking each one of said signal trace units as a center one by one, and then enveloping the predetermined number of regions of said first ground vias, regions of said second ground vias and each of said signal trace units as said first non-simplified region unit.

4. The selecting method of first non-simplified region as claimed in claim 3, wherein in said third selecting mode, selecting a virtual window with each said signal trace units as a center, enlarging said window to a first size, and determining whether said window covers said first ground vias in said first grounding metal zone; enlarging said window to a second size, and determining whether said window covers said second ground vias in said second coplanar grounding metal zone; defining a distance between a center of said window and said first ground via that is farthest from the center of said window to be a selecting radius, defining a distance between the center of said window and said second ground via that is farthest from the center of said window to be another selecting radius, and then selecting said first non-simplified region according to said two selecting radii.

5. An automatic simplification mechanism of 3D model of multilayer metal circuit structure, which uses a computer to establish a complete 3D model based on a layout design of a multilayer metal circuit structure and simplifies said complete 3D model into a simplified 3D model, said complete 3D model comprising a plurality of layout layers, the automatic simplification mechanism comprising the steps of:
selecting said first non-simplified region according to the selecting method of said first non-simplified region as claimed in claim 1;
obtaining at least one remaining non-simplified region according to a trace-to-trace isolation, a via-to-via isolation, or a via-to-trace isolation of said complete 3D model;
enveloping said first non-simplified region and said at least one remaining non-simplified region as a closed region, defining a region other than the closed region that is enveloped as a simplified region, replacing said simplified region by a metal structure, and jointly establishing said simplified 3D model by said metal structure and a layout of the closed region that is enveloped.

6. The automatic simplification mechanism as claimed in claim 5, wherein in the step of obtaining said at least one remaining non-simplified region according to said trace-to-trace isolation, further comprising the sub-steps of:
searching a first signal trace, a second signal trace adjacent to said first signal trace, a plurality of first ground vias around a periphery of said first signal trace, and a plurality of second ground vias around a periphery of said second signal trace in said layout layers of said complete 3D model;
dividing said first signal trace into a plurality of first signal trace units, and dividing said second signal trace into a plurality of second signal trace units;
searching a first predetermined number of said first ground vias by taking each of said first signal trace units as a center one by one, and enveloping said first predetermined number of said first ground vias and a corresponding region to each of said first signal trace units to select a second non-simplified region unit, and searching a second predetermined number of said second ground vias by taking each of said second signal trace units as a center one by one, and enveloping said second predetermined number of said second ground vias and a corresponding region to each of said second signal trace units to select a third non-simplified region unit; and
combining each of said second non-simplified region units as a second non-simplified region, and combining each of said third non-simplified region units as a third non-simplified region, and enveloping said second and third non-simplified regions as a closed region so as to obtain said at least one remaining non-simplified region.

7. The automatic simplification mechanism as claimed in claim 5, wherein in the step of obtaining said at least one remaining non-simplified region according to said via-to-via isolation, further comprising the sub-steps of:
searching a first signal trace, a second signal trace adjacent to said first signal trace, a plurality of first ground vias around a periphery of said first signal trace, and a plurality of second signal vias around a periphery of said second signal trace in said layout layers of said complete 3D model;
taking each of said first signal vias as a center one by one, determining whether any one of said second signal vias exists within a first predetermined distance, if the determining result is true, defining a distance between the closest said second signal via and said first signal via as a selecting radius and then selecting a fourth non-simplified region unit and combining said fourth non-simplified region unit each as a fourth non-simplified region;
taking each of said second signal vias as a center one by one, determining whether any one of said first signal vias exists within a predetermined distance, if the determining result is true, defining a distance between the closest said first signal via and said second signal via as another selecting radius and then selecting a fifth non-simplified region unit, combining said fifth non-simplified region unit each as a fifth non-simplified region; and
enveloping said fourth and fifth non-simplified regions as a closed region to obtain said at least one remaining non-simplified region.

8. The automatic simplification mechanism as claimed in claim 5, wherein in the step of obtaining said at least one remaining non-simplified region according to said via-to-trace isolation, further comprising the sub-steps of:
in said layout layers of said complete 3D model, searching a plurality of signal aggressors and a signal trace adjacent to said signal aggressors;
taking each one of said signal aggressors as a center one by one, selecting a sixth non-simplified region unit according to a selecting radius, said sixth non-simplified region unit covering a predetermined length of said signal trace; and
combining said sixth non-simplified region units each as a sixth non-simplified region, and then said sixth non-simplified region is thus said at least one remaining non-simplified region.
